(19) United States
(12) Patent Application Publication
(10) Pub. No.: US 2018/0144404 A1
(43) Pub. Date: May 24, 2018

(54) EXTENDED LEGAL CONTROL CHECKING

(71) Applicant: SAP SE, Walldorf, DE (US)

(72) Inventors: Thorsten REFIOR, Weinheim (DE); Qi YANG, Shanghai (CN); Jun LI, Shanghai (CN)

(21) Appl. No.: 15/359,630

(22) Filed: Nov. 23, 2016

(51) Int. Cl. G06Q 40/04

(52) U.S. Cl. CPC G06Q 40/04; G06Q 50/18

(57) ABSTRACT

Described herein is a framework for extended legal control checking. In accordance with one aspect, an export legal control check and a domestic legal control check are performed based on an export customs document to generate first and second results. An import legal control check may further be performed based on an import customs document to generate third results. The first, second and third results may then be presented.

### TECHNICAL FIELD

The present disclosure relates generally to computer systems, and more specifically, to a framework for extended legal control checking.

### BACKGROUND

Products are commonly manufactured in one country and shipped to customers in another country. To document such international transactions, documents are issued to indicate the purchase and delivery terms. FIG. 1 illustrates an exemplary document flow 100 in an international transaction. An end customer 102 in country A may issue a sales order to buy goods from a domestic seller 104 in the same country A. The seller 104 then issues a customer invoice indicating the payment terms to the end customer 102. The seller 104 may issue another purchase order to order the goods from a supplier 106 in another country B. The supplier 106 may issue an intercompany invoice to seller 104 in return. After the goods are manufactured, the supplier 106 may deliver (e.g., drop-ship) the goods along with a delivery order to the end customer 102 in country A.

Such international transactions are governed by trade regulations of the respective countries A and B. The documents are typically manually inspected to determine if the attributes (e.g., value, quantity) comply with the trade regulations. For example, the law may indicate that a maximum of 1000 computers can be sold each year by one company. Such document inspection is typically cumbersome and time consuming.

### SUMMARY

A framework for extended legal control checking is provided herein. In accordance with one aspect, an export legal control check and a domestic legal control check are performed based on an export customs document to generate first and second results. An import legal control check may further be performed based on an import customs document to generate third results. The first, second and third results may then be presented.

### BRIEF DESCRIPTION OF THE DRAWINGS

Some embodiments are illustrated in the accompanying figures, in which like reference numerals designate like parts, and wherein:

FIG. 1 illustrates an exemplary document flow in an international transaction;

FIG. 2 is a block diagram illustrating an exemplary architecture;

FIG. 3 shows an exemplary method for performing extended legal control checks;

FIG. 4a shows an exemplary user interface screen that displays an export customs document;

FIG. 4b shows an exemplary user interface screen that displays an import customs document;

FIG. 5 shows an exemplary user interface screen that displays the aggregated results;

FIG. 6 shows a log output that indicates the types of checks that have been performed for the sales order;

FIG. 7 shows an exemplary method for performing a legal control check;

FIG. 8a shows an exemplary user interface screen that displays active legal regulations for manual license assignment;

FIG. 8b shows exemplary rules for determining license types;

FIG. 9 shows an exemplary method for checking a customs document item to determine whether it qualifies to obtain at least one license;

FIGS. 10a-10b shows exemplary license selection criteria; and

FIG. 11 shows exemplary objects that can be checked during the determination of a qualified license.

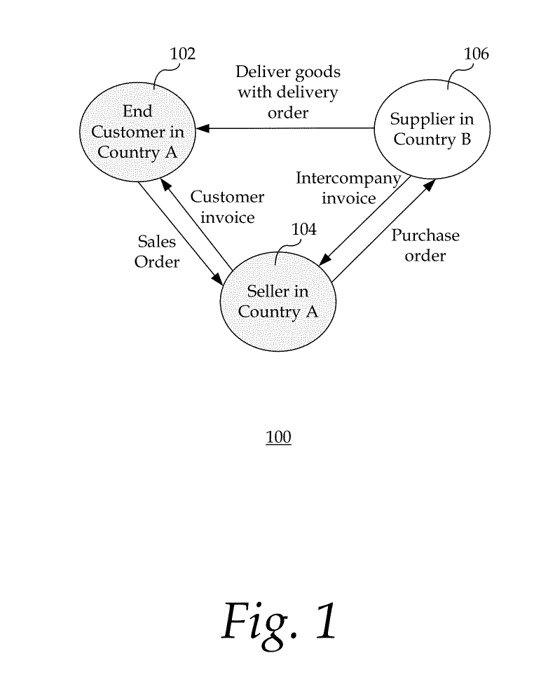

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for extended legal control checking is described herein. One aspect of the present framework performs one or more directional legal control checks for parties in the same or different countries. In some implementations, an export customs document is generated based on a document (e.g., sales order, delivery order, and/or purchase order). The framework then performs an export legal control check from a supplier (e.g., manufacturer) in one country to an end user in another country. The framework may also perform a domestic legal control check from a seller to an end customer in the same country. An import customs document may be generated based on the export customs document. An import legal control may be performed from the supplier in one country to the seller in another country. The results of the directional legal control checks may then be aggregated and returned.

It should be appreciated that the framework described herein may be implemented as a method, a computer-controlled apparatus, a computer process, a computing system, or as an article of manufacture such as a computer-usable medium. These and various other features and advantages will be apparent from the following description.

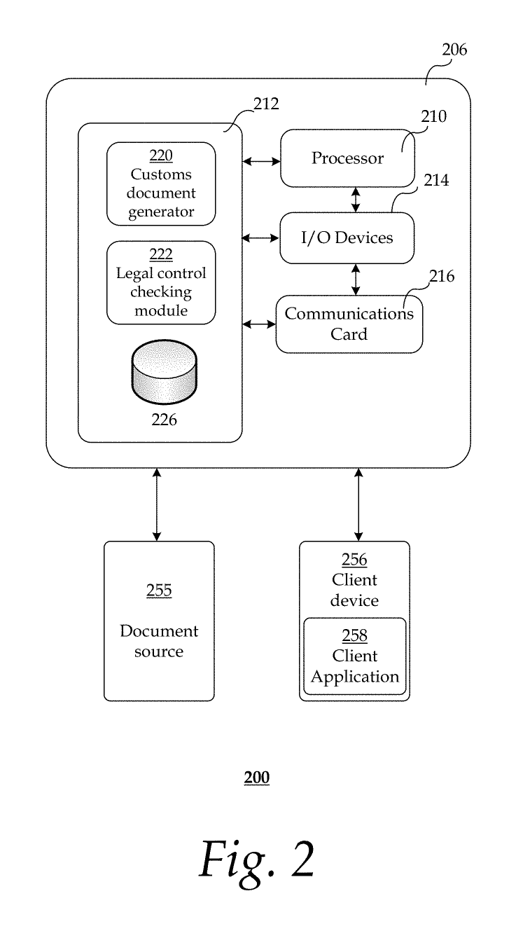

FIG. 2 is a block diagram illustrating an exemplary architecture 200 in accordance with one aspect of the present framework. Generally, exemplary architecture 200 may include a server 206, a document source 255 and one or more client devices 256.

Server 206 may include a processor (or processor device) 210, input/output (I/O) devices 214 (e.g., touch screen, keypad, touch pad, display screen, speaker, etc.), a memory module 212, and a communications card or device 216 (e.g., modem and/or network adapter) for exchanging data with a network (e.g., local area network (LAN), wide area network (WAN), Internet, etc.). It should be appreciated that the different components and sub-components of the server 206 may be located or executed on different machines or systems. For example, a component may be executed on many computer systems connected via the network at the same time (i.e., cloud computing).

Memory module 212 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks or cards, magneto-optical disks, Compact Disc Read-Only Memory (CD-ROM), any other volatile or non-volatile memory, or a combination thereof. Memory module 212 serves to store machine-executable instructions, data, and various software components for implementing the techniques described herein, all of which may be processed by processor 210. As such, server 206 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In some implementations, memory module 212 includes a customs document generator 220, a legal control checking module 222 and a database 226. Database 226 may include, for example, information associated with trade regulations, licenses and associated rules. Alternatively, such information may be retrieved from an external data source (not shown).

Server 206 may operate in a networked environment using logical connections to a document source 255 and one or more client devices 256. The document source 255 may serve to create and/or store documents, such as sales orders, purchase orders, delivery orders, customer and/or intercompany invoices. In some implementations, the document source 255 includes an enterprise resource planning (ERP) system that can be used to collect, store, manage and interpret data from many activities, such as product planning, manufacturing, marketing, sales, finance and so forth. Each client device 256 may include a client application 258 configured to present a user interface (e.g., graphical user interface) to access the services provided by server 206.

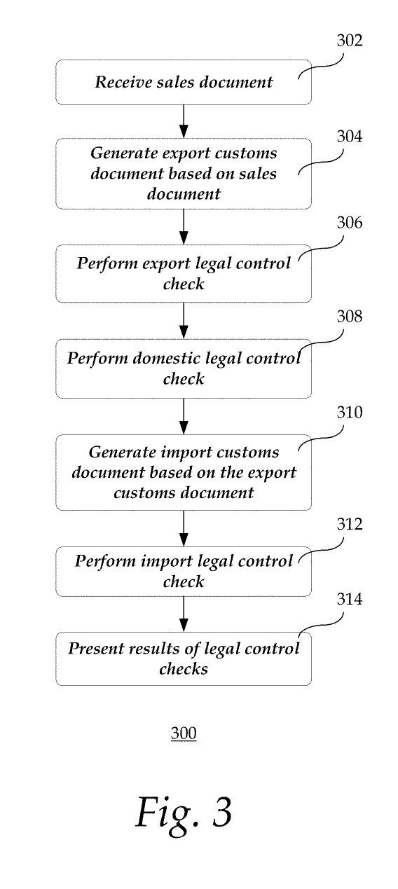

FIG. 3 shows an exemplary method 300 for performing extended legal control checks. The method 300 may be performed automatically or semi-automatically by the system 200, as previously described with reference to FIG. 2. It should be noted that in the following discussion, reference will be made, using like numerals, to the features described in FIG. 2.

At 302, customs document generator 220 receives a sales document from document source 255. Such sales document includes, for example, a sales order, purchase order, delivery order, customer invoice, intercompany (or cross company) invoice, or other document providing information about a transaction. The sales document may be generated using, for example, an enterprise resource planning (ERP) system.

The document may contain transactional data associated with an order of goods from an end customer in country A be sent to a domestic seller in the same country A. The transactional data includes, for example, quantity of goods, price, description of goods, origin address, shipping destination, and/or payment terms. The order may also be sent from the domestic seller to a foreign supplier (e.g., manufacturer) in country B. The goods may be delivered directly (e.g., drop-shipped) by the foreign supplier to the end customer.

At 304, customs document generator 220 generates an export customs document based on the sales document. The export customs document may be used to declare the export of goods to customs authorities in the exporting country (e.g., country B). Each export document may include a list of one or more document items corresponding to one or more goods (or sets of goods). The information, that is extracted from the sales document to generate the export customs document, depends on the applicable export customs authority regulations specific to the country (or country group) of export.

To determine if extended legal control checking has been enabled, legal control checking module 222 may first check a flag value in the export customs document that indicates that the user has selected (e.g., via a user interface) the extended legal control checking function. Legal control checking module 222 may further verify, based on the export customs document or sales document, that a cross-company scenario exists. A cross-company scenario exists when the country of the shipping party (e.g., supplier of goods) is different from the country of the sales organization. If so, the process 300 may continue to steps 306 through 314 to perform the extended legal control checks. If not, the process 300 may end after step 306.

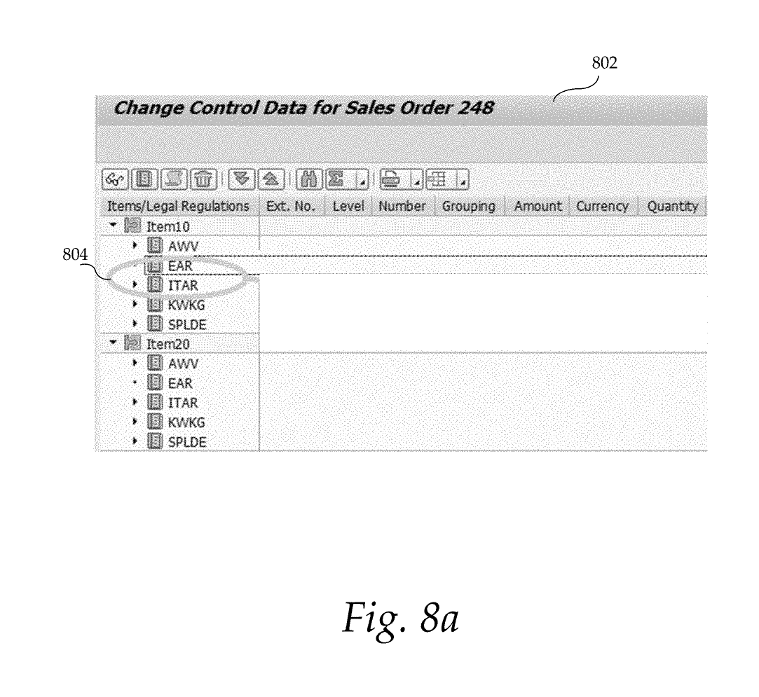

At 306, legal control checking module 222 performs an export legal control check on each item of the export customs document. The export legal control check may be made in response to determining that extended legal control checking has been enabled, as previously described. The export legal control check is performed from the supplier in one country (e.g., country B) to a user in another country (e.g., country A). The export legal control check may be implemented by the process 700 described herein with reference to FIG. 7. The export legal control check determines whether the export customs document items comply with the export regulations (or rules) for obtaining at least one export license from the relevant authorities. An export license indicates that the authorities have granted the exporter (e.g., foreign supplier) the right to export the specified goods to the specified countries (e.g., country A). Exemplary export regulations include, but are not limited to, Germany's foreign trade regulation (AWV), international traffic in arms regulations (ITAR) and Germany's war weapons control act (KWKG). Other types of regulations may also be applied, depending on the country of export.

At 308, legal control checking module 222 performs a domestic legal control check on each item of the export customs document. The domestic legal control check is performed from the domestic seller to the end customer in the same country. The domestic legal control check may be implemented by the process 700 described herein with reference to FIG. 7. The domestic legal control check determines whether the export customs document items comply with domestic regulations for obtaining at least one domestic license to trade the specified goods. An exemplary domestic regulation is Germany's War Weapons Control Act (KWKG or Kriegswaffenkontrollgesetz), which handles not only the export, but also the transfer of war weapons or materials that can be used to build them.

At 310, customs document generator 220 generates an import customs document based on the export customs document. The import customs document may be used to declare the import of goods to customs authorities in the importing country (e.g., country A). The information, extracted from the export customs document to generate the import customs document, depends on the applicable customs authority regulations specific to the country (or country group) of import. Each import document may include a list of one or more document items corresponding to one or more goods (or sets of goods).

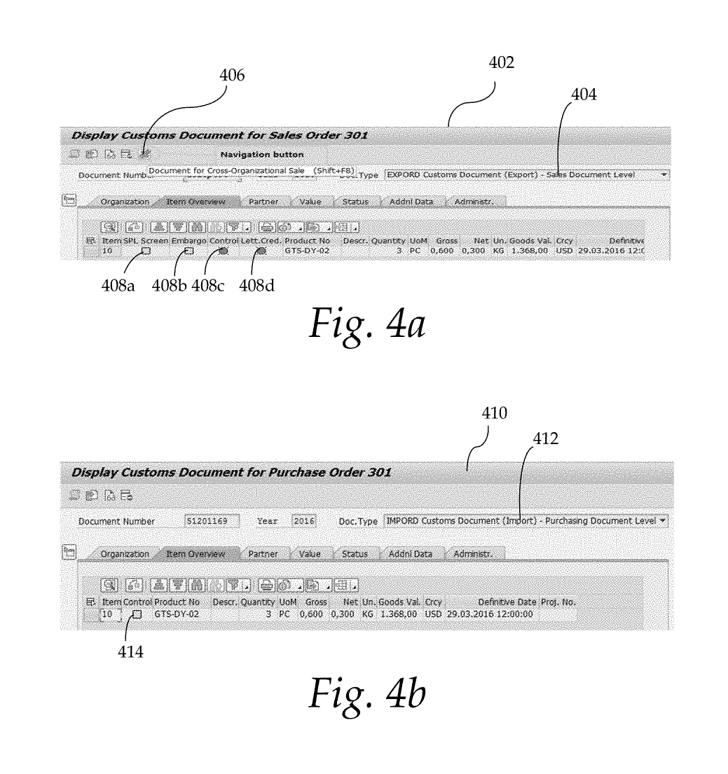

FIG. 4a shows an exemplary user interface screen 402 that displays an export customs document 404. As shown, the export customs document 404 contains information about each document item, such as product number, description, quantity, unit of measure (UoM) gross and net weight, unit, goods value, currency, definitive date, etc. In addition, the user interface screen 402 includes icons 408a-d that are color coded, shaped and/or shaded to indicate whether errors are encountered in the different types of checks associated with the export customs document 404. For example, green square icons 408a-b indicate the sanctioned party list (SPL) screening and embargo checks were successfully completed without any errors, while red circle icons 408c-d indicate that errors were encountered during the export legal control and letter of credit checks. The user interface screen 402 includes a navigation button 406 that is user-selectable to display the generated import customs document.

FIG. 4b shows an exemplary user interface screen 410 that displays an import customs document 412. The import customs document 412 contains information about a document item, such as product number, description, quantity, unit of measure (UoM), gross and net weight, unit, goods value, currency, definitive date, etc. In addition, the user interface screen 410 includes an icon 414 that is color coded, patterned or shaded to indicate whether errors were encountered in the legal control check associated with the import customs document 412.

At 312, legal control checking module 222 performs an import legal control check on each item of the import customs document. The import legal control check is performed from the supplier in one country (e.g., country B) to the seller in another country (e.g., country A). The import legal control check may be implemented by the process 700 described herein with reference to FIG. 7. The import legal control check determines whether the import customs document items comply with the import regulations for obtaining at least one import license from the relevant authorities. An exemplary import regulation is the international traffic in arms regulations (ITAR). An import license indicates that a government has granted the importer (e.g., seller) the right to import the specified goods into the specified countries (e.g., country A).

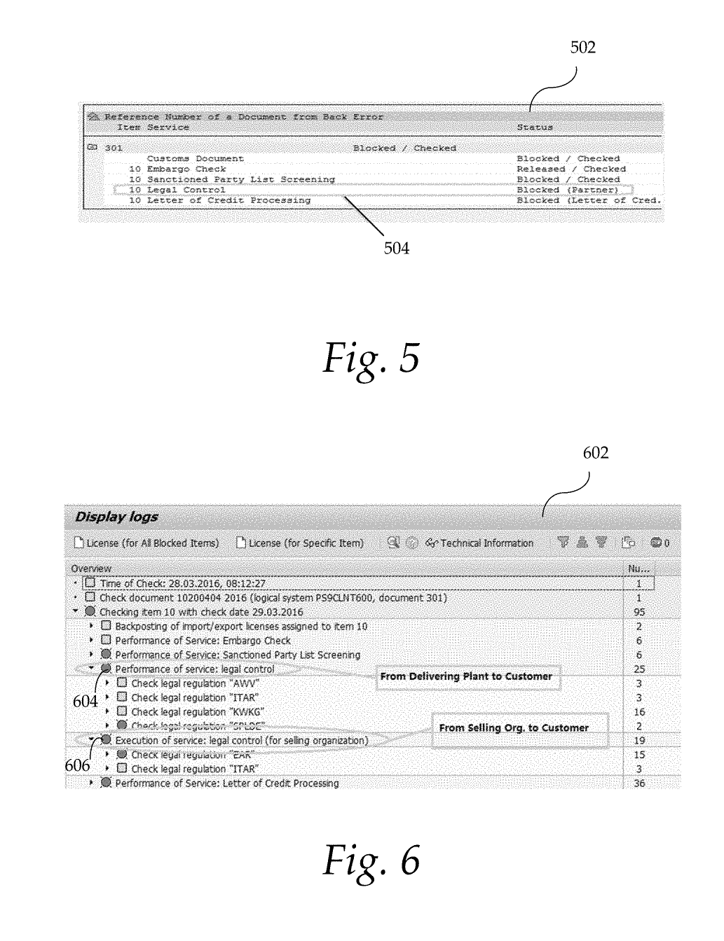

At 314, legal control checking module 222 presents results of the export, domestic and import legal control checks. FIG. 5 shows an exemplary user interface screen 502 that displays aggregated results 504. As shown, the status icon 504 of the legal control check is updated to “Blocked (Partner)”. This means that the legal control checks have failed, because the legal control checking module 222 was unable to determine a valid country of a partner (e.g., vendor, supplier, ship-to party, assignee) to find at least one of the licenses. In other scenarios where the export, domestic and import legal control checks have been successfully completed, the status 504 may be updated to “Released/Checked”.

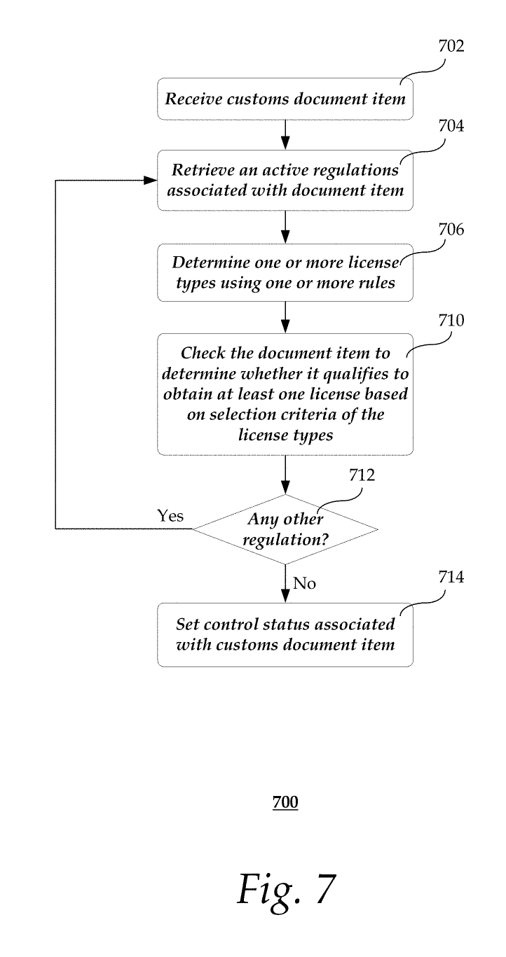

FIG. 6 shows a log output 602 that indicates different legal control checks that have been performed in association with the sales order. As indicated by respective icons 604 and 606 and associated text, errors were encountered during the export legal control check from the foreign supplier to the end customer and domestic and import legal control checks for the seller.

FIG. 7 shows an exemplary method 700 for performing a legal control check. The method 700 may be performed automatically or semi-automatically by the system 200, as previously described with reference to FIG. 2. It should be noted that in the following discussion, reference will be made, using like numerals, to the features described in FIG. 2.

At 702, legal control checking module 222 receives a customs document item. The customs document item may describe goods in an export customs document or an import customs document. The customs document may be generated by customs document generator 220, as previously described at 304 with reference to FIG. 3.

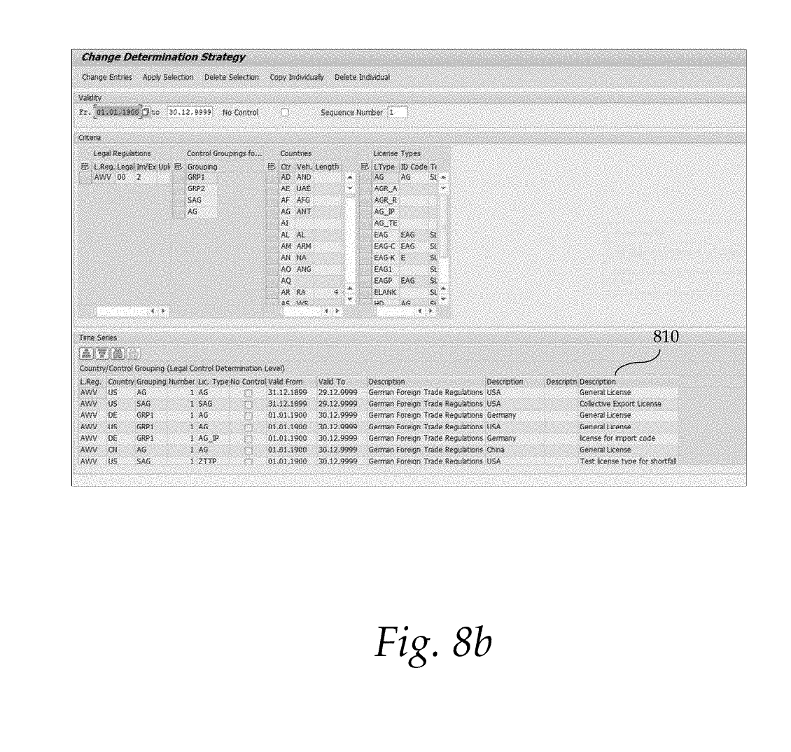

At 704, legal control checking module 222 retrieves an active regulation associated with the customs document item. The one or more active regulations may be retrieved by querying database 226 or any other data source. Each regulation may be activated or deactivated via the user interface. The type of regulation may be export, import or domestic regulation, depending on the type of legal control check being performed. FIG. 8a shows an exemplary user interface screen 802 that displays the active (or activated) legal regulations 804 for manual license assignment. Active legal regulations 804 are determined by legal requirements associated with the departure country (or country group) and destination country (or country group) pairs specified in an export customs document item, or vice versa for an import customs document item.

Returning to FIG. 7, at 706, for each active regulation, legal control checking module 222 determines one or more license types using one or more rules according to the active regulation. A license may be an export, import or domestic license, depending on the type of legal control check being performed. The license indicates that the authorities have granted the exporter, importer or seller the right to ship the specified goods. Each country (or country group) have different types of export, import or domestic licenses. For example, in the United States, a license is only required to export certain products or to export to certain countries. If an export requires a license, the exporter needs to check whether a license is really needed for the shipment or whether a license exception applies. Depending on the country of destination and the product, the authorities (e.g., Bureau of Industry and Security) may grant either a General License or Individual License for exports that require a license. A general license may be granted for all exports of specific products, whereas an individual license may be granted for specific products for one shipment or several shipments in a specific period.

The rules may be retrieved by querying database 226 or any other data source. FIG. 8b shows exemplary table 810 of rules for determining license types. Each row of the table 810 specifies attributes of a rule for determining a particular license type (e.g., general, individual or collective export license). More particularly, the attributes that define a rule may include, but are not limited to, the associated legal regulation, the destination country, license type, validity period, description, etc.

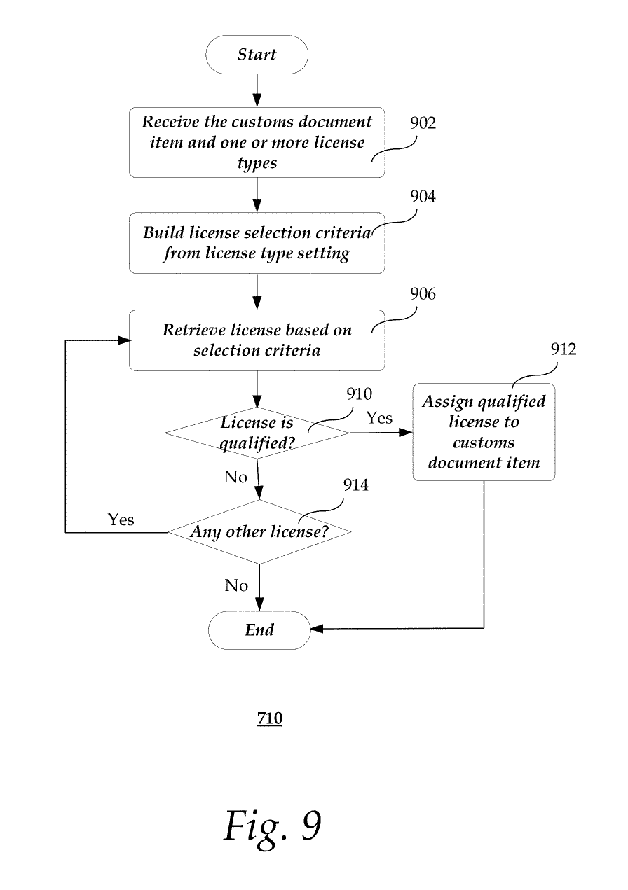

At 710, legal control checking module 222 checks the customs document item to determine whether it qualifies to obtain at least one license based on selection criteria associated with the one or more license types. More details of this step will be provided herein with reference to FIG. 9.

At 712, legal control checking module 222 determines if there is another active regulation to be checked. If so, the process 700 returns to 706. Else, the process 700 continues to 714.

At 714, legal control checking module 222 sets the control status associated with the customs document item based on results of the legal control check. The control status indicates whether the legal control check was completed successfully or not. The legal control check was completed successfully if the document item qualifies for at least one license. The control status may be represented by, for example, an icon (604, 606) in a log output 602, as shown in FIG. 6.

FIG. 9 shows an exemplary method for checking a customs document item to determine whether it qualifies to obtain at least one license. The method 710 may be performed automatically or semi-automatically by the system 200, as previously described with reference to FIG. 2. It should be noted that in the following discussion, reference will be made, using like numerals, to the features described in FIG. 2.

At 902, legal control checking module 222 receives the customs document item and one or more license types.

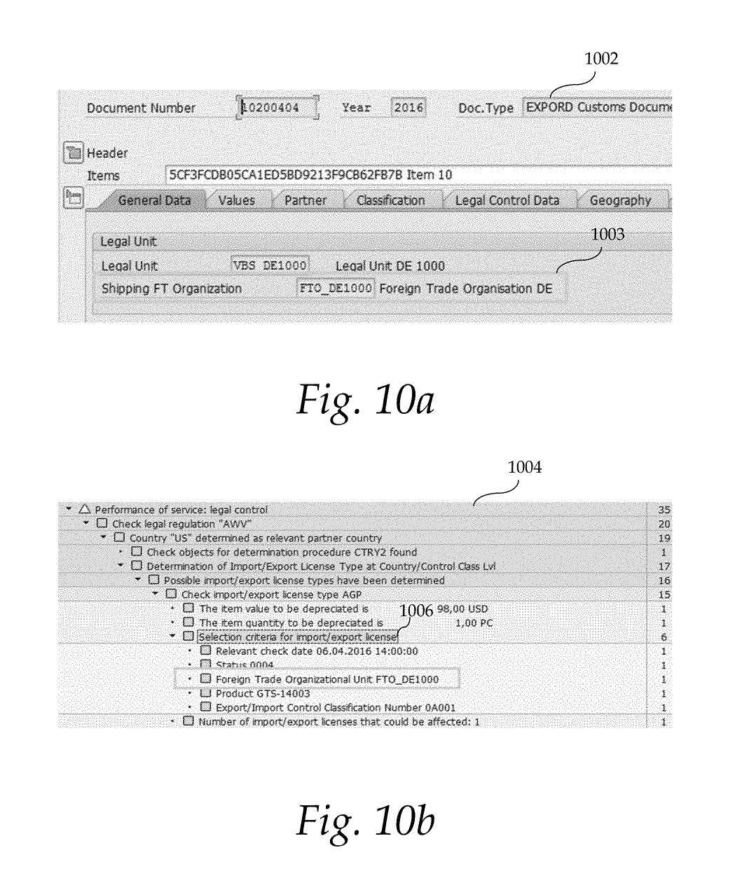

At 904, legal control checking module 222 builds license selection criteria from the license type setting. FIGS. 10a-10b show exemplary license selection criteria that take into account the Foreign Trade Organization (FTO) of the delivering supplier. In FIG. 10a, the user interface screen 1002 displays the FTO unit 1003 of the supplier at the item level. In FIG. 10b, the user interface screen 1004 displays the selection criteria 1006 for an import/export license. The selection criteria 1006 is defined by the relevant check date, the status, the FTO unit, the product serial number and the control classification number.

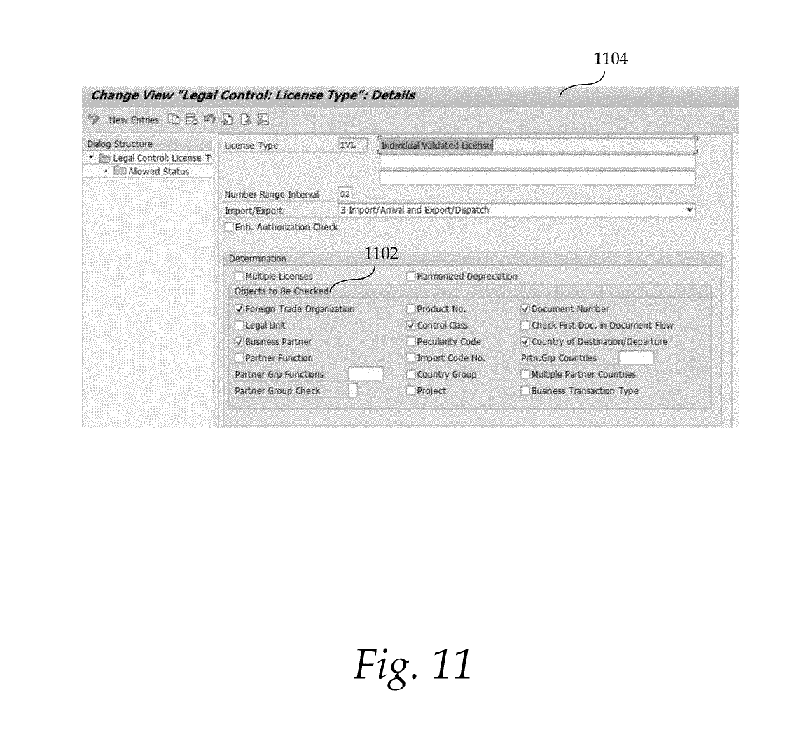

Returning to FIG. 9, at 906, legal control checking module 222 retrieves a license based on the selection criteria. The license may be retrieved by querying database 226 or another data source. The license may be an export, domestic or import license. Each license may be described by objects. FIG. 11 shows exemplary objects (or attributes) 1102 that can be checked during the determination of a qualified license As shown, the exemplary license objects 1102 to be checked may be selected (or deselected) by the user via the user interface screen 1104. The license objects 1102 include, but are not limited to, foreign trade organization, legal unit, business partner, partner function, product number, control class, peculiarity code, import code number, country group, project, document number, check first document in document flow, country of destination/departure, multiple partner countries, business transaction type, etc.

At 910, legal control checking module 222 determines if the license is qualified. The license is qualified if the customs document satisfies the license objects. If the license is qualified, it is assigned to the customs document item at 912. The process 710 then ends. If not, the process 710 continues to 914.

At 914, legal control checking module 222 determines if any remaining license is to be processed. If so, legal control checking module 222 repeats step 906 to process the next license. If not, the process 710 ends.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A system for extended legal control checking, comprising:
a non-transitory memory device for storing computer-readable program code; and
a processor in communication with the memory device, the processor being operative with the computer-readable program code to perform operations including
generating an export customs document based on a sales document,
performing an export legal control check based on the export customs document to generate first results,
performing a domestic legal control check based on the export customs document to generate second results,
generating an import customs document based on the export customs document,
performing an import legal control check based on the import customs document to generate third results, and
presenting the first, second and third results.

2. The system of claim 1 wherein the sales document comprises a sales order, a purchase order, a delivery order, a customer invoice or an intercompany invoice.

3. The system of claim 1 wherein the processor is operative with the computer-readable program code to perform the export legal control check in response to determining that extended legal control checking has been enabled.

4. The system of claim 3 wherein the processor is operative with the computer-readable program code to determine that extended legal control checking has been enabled by
checking a flag value in the export customs document that indicates a user has selected a function to perform the extended legal control checking; and
verifying that a cross-company scenarios exists.

5. A computer-implemented method, comprising:
performing an export legal control check based on an export customs document to generate first results;
performing a domestic legal control check based on the export customs document to generate second results;
performing an import legal control check based on an import customs document to generate third results; and
presenting the first, second and third results.

6. The method of claim 5 wherein performing the export legal control check comprises determining whether one or more items in the export customs document comply with export regulations for obtaining at least one export license from relevant authorities.

7. The method of claim 5 wherein performing the domestic legal control check comprises determining whether one or more items in the export customs document comply with domestic regulations for obtaining at least one domestic license from relevant authorities.

8. The method of claim 5 wherein performing the import legal control check comprises determining whether one or more items in the import customs document comply with import regulations for obtaining at least one import license from relevant authorities.

9. The method of claim 5 further comprises generating the import customs document based on the export customs document.

10. The method of claim 5 wherein presenting the first, second and third results comprises displaying a status icon that indicates whether the export, domestic and import legal control checks were successfully completed or not.

11. The method of claim 5 wherein presenting the first, second and third results comprises displaying a log that indicates the first, second and third results of the export, domestic and import legal control checks.

12. The method of claim 5 wherein performing the export legal control check comprises:
determining, using one or more rules, one or more license types associated with an item of the export customs document;
checking the item to determine whether the item qualifies to obtain at least one export license based on selection criteria of the one or more license types; and
setting, based on results of the checking, a control status associated with the item.

13. The method of claim 12 further comprises retrieving one or more active export regulations for determining the one or more rules.

14. The method of claim 12 wherein the one or more license types comprise a general license or an individual license.

15. The method of claim 12 wherein checking the item to determine whether the item qualifies to obtain at least one export license based on selection criteria of the one or more license types comprises:
building the selection criteria from settings of the one or more license types;
retrieving the at least one export license based on the selection criteria; and
determining whether the at least one export license is qualified.

16. The method of claim 5 wherein performing the domestic legal control check comprises:
determining, using one or more rules, one or more license types associated with an item of the export customs document;
checking the item to determine whether the item qualifies to obtain at least one domestic license based on selection criteria of the one or more license types; and
setting, based on results of the checking, a control status associated with the item.

17. The method of claim 16 further comprises retrieving one or more active domestic regulations for determining the one or more rules.

18. The method of claim 16 wherein checking the item to determine whether the item qualifies to obtain at least one domestic license based on selection criteria of the one or more license types comprises:
building the selection criteria from settings of the one or more license types;
retrieving the at least one domestic license based on the selection criteria; and
determining whether the at least one domestic license is qualified.

19. The method of claim 5 wherein performing the import legal control check comprises:
determining, using one or more rules, one or more license types associated with an item of the import customs document;
checking the item to determine whether the item qualifies to obtain at least one import license based on selection criteria of the one or more license types; and
setting, based on results of the checking, a control status associated with the item.

20. A non-transitory computer-readable medium having stored thereon program code, the program code executable by a computer to perform steps comprising:
performing an export legal control check based on an export customs document to generate first results;
performing a domestic legal control check based on the export customs document to generate second results;
performing an import legal control check based on an import customs document to generate third results; and
presenting the first, second and third results.
